(19) United States
(12) Patent Application Publication
(10) Pub. No.: US 2022/0245744 A1
(43) Pub. Date: Aug. 4, 2022

(54) METHODS AND SYSTEMS OF AN UNBIASED MIDDLE ENTITY TO LEGALLY VERIFY AND/OR NOTARIZES DIGITAL INTERACTIONS ALONG WITH INTERACTION DATA BETWEEN PARTIES

(71) Applicants: MEYYAPPAN ALAGAPPAN, fremont, CA (US); RAJ KISHOR KHAWARE, PLEASANTON, CA (US)

(72) Inventors: MEYYAPPAN ALAGAPPAN, fremont, CA (US); RAJ KISHOR KHAWARE, PLEASANTON, CA (US)

(21) Appl. No.: 17/163,557

(22) Filed: Jan. 31, 2021

(51) Int. Cl. G06Q 50/18; H04L 9/08

(52) U.S. Cl. CPC G06Q 50/18; H04L 9/088

(57) ABSTRACT

In one aspect, a digitized solution for an unbiased entity to verify and/or notarize/attest digital interactions along with interaction data between parties. The parties can be corporate entities or consumers and a between parties relationship can refer to corporate to corporate, corporate to consumer, consumer to consumer or group of corporate entities and consumers The digital interaction comprises consent agreement, data rights access, notifications/alerts, use of services and communications. A verify operation involves identifying the identity of the parties and their use of digital services. A verification of identity involves the verification by email, verification by SMS and/or verification by a Hypertext Transfer Protocol (HTTP) cookie. Notarizing or attesting involves a process of collecting interaction data. The interaction data comprises an interaction term, an interaction detail , an interaction message, a time of event, an internet protocol address, a location, a digital fingerprint. The digitized solution stores the interaction data in a centralized system where the interaction data is accessible to all relevant parties.

### CLAIM OF PRIORITY

This application claims priority to U.S. patent application Ser. No. 16746278, titled METHODS AND SYSTEMS OF AN UNBIASED MIDDLE ENTITY TO LEGALLY VERIFY AND MANAGE CONSUMER CONSENT OR ACCEPTANCE, filed on 17 Jan. 2020. This application is hereby incorporated by reference in its entirety.

### BACKGROUND

User privacy has become an important aspect of social life. Governments around the world have passed regulations to safeguard user privacy. These regulations often require corporate entities to obtain a formal acceptance or consent for their privacy agreement with the consumers before collecting their privacy information. Unfortunately, the acceptance of this agreement is not legally verifiable as it may be directly collected by the corporations through their websites. At any point of time the user or the corporate can deny this acceptance or the agreement terms as no third party is involved to attest this acceptance. Therefore, an unbiased middle entity can be used to improve this process by attesting and verifying the privacy agreement acceptance between the user and the corporation.

Additionally, it is noted that there are currently various required privacy notices on web sites and contact details. Accordingly, there is a potential problem for corporate entities when privacy enquires are not attested. Corporate entities need methods to avoid missing a submission timeline based on the privacy laws. Problems can arise when templating legal responses or email service spam enquires or responses land in an email junk folder.

Additionally, there is a need to provide user/consumers the ability to access or delete the submitted personal information on a specified timeline (e.g. CCPA timeline, etc.). In one example, this can be as follows: acknowledge in 10 days, comply in 15 days, and respond in 45 days audit trail, etc. The corporate entity has a due to track all communication and there can be penalties for failing to do so (e.g. $2500 for each violation, $7500 if intentional violation, etc.).

Additionally, corporate-to-corporate communications can include privacy related communications. Corporations can authorize other corporate entities to use the collected PII information of a consumer Corporations can also revoke access ,manage and modify PII information.

Additionally, consumers who provided consent for corporates to collect their personal data (PII) don't have a centralized platform to review the terms/conditions, view, revoke and manage all the consents provided by them to different corporates. A centralized system will help them easily aggregated and manage all the provides consents in one place/platform.

### BRIEF SUMMARY OF THE INVENTION

In one aspect, a digitized solution for an unbiased entity to verify and/or notarize/attest digital interactions along with interaction data between parties. The parties can be corporate entities or consumers and a between parties relationship can refer to corporate to corporate, corporate to consumer, consumer to consumer or group of corporate entities and consumers The digital interaction comprises consent agreement, data rights access, notifications/alerts, use of services and communications. A verify operation involves identifying the identity of the parties and their use of digital services. A verification of identity involves the verification by email, verification by SMS and/or verification by a Hypertext Transfer Protocol (HTTP) cookie. Notarizing or attesting involves a process of collecting interaction data. The interaction data comprises an interaction term, an interaction detail , an interaction message, a time of event, an internet protocol address, a location, a digital fingerprint. The digitized solution stores the interaction data in a centralized system where the interaction data is accessible to all relevant parties.

### BRIEF DESCRIPTION OF THE DRAWINGS

FIG. 1 illustrates an example process for enabling an unbiased middle entity to manage privacy inquiry requirements, according to some embodiments.

FIGS. 2-4 illustrate example screen shots for the implementation of process 500, according to some embodiments.

FIG. 5 illustrates an example process for implementing an enquiry submission, according to some embodiments.

FIGS. 6-7 illustrate a set of example screen shots for implementation of process 800, according to some embodiments.

FIG. 8 illustrates an example process for implementing an opt-in verification, according to some embodiments.

FIG. 9 illustrate a set of example screen shots for implementation of process 1000, according to some embodiments.

FIG. 10 illustrate an example process, according to some embodiments.

FIG. 11 illustrates an example of a centralized platform that maintains all the interaction between corporates and consumers in one common place, according to some embodiments.

The Figures described above are a representative set, and are not an exhaustive with respect to embodying the invention.

### DESCRIPTION

Disclosed are a system, method, and article of an unbiased middle entity to legally verify and/or notarizes digital communication between corporate to corporate, corporate to consumer and consumer to corporate to manage privacy related communications. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Example definitions for some embodiments are now provided.

Application programming interface (API) can specify how software components of various systems interact with each other.

Cloud computing can involve deploying groups of remote servers and/or software networks that allow centralized data storage and online access to computer services or resources. These groups of remote serves and/or software networks can be a collection of remote computing services.

California Consumer Privacy Act (CCPA) is a bill that enhances privacy rights and consumer protection for residents of California, United States. The bill was passed by the California State Legislature and signed into law by Jerry Brown, Governor of California, on Jun. 28, 2018, to amend Part 4 of Division 3 of the California Civil Code.

HTTP cookie (e.g. a cookie) is a small piece of data sent from a website and stored on the user's computer by the user's web browser while the user is browsing. Cookies can be used by a websites as a mechanism to remember stateful information (e.g. as items added in the shopping cart in an online store) and/or to record the user's browsing activity (e.g. clicking specified buttons, logging in, recording visited in the past, etc.).

General Data Protection Regulation (GDPR) is a regulation in EU law on data protection and privacy for all individual citizens of the European Union (EU) and the European Economic Area (EEA). It also addresses the transfer of personal data outside the EU and EEA areas. The GDPR aims primarily to give control to individuals over their personal data and to simplify the regulatory environment for international business by unifying the regulation within the EU.

Children's Online Privacy Protection Act of 1998 (COPPA) is a United States (U.S.) federal law that applies to the online collection of personal information by persons or entities under U.S. jurisdiction about children under thirteen (13) years of age including children outside the U.S. if the company is U.S.-based. It details what a website operator must include in a privacy policy, when and how to seek verifiable consent from a parent or guardian, and what responsibilities an operator has to protect children's privacy and safety online including restrictions on the marketing of those under thirteen (13).

Personal data (PII) is any information relating to an identifiable person such as personally identifiable information.

### EXAMPLE METHODS OF UNBIASED MIDDLE ENTITY TO MANAGE PRIVACY INQUIRY REQUIREMENTS

The unbiased middle entity is used to legally verify and/or notarizes digital communication between various specified entities. These entities can include, inter alia: corporate to corporate, corporate to consumer and consumer to corporate interactions. The unbiased middle entity can be used to manage PII information. The unbiased middle entity can provide authorization to use, revoke and/or create inquiries to delete, access and modify.

For example, a consumer can authorize a corporate entity to use some aspect of the user's PII data in a specified manner. The consumer can use the unbiased middle entity to revoke and/or modify this authorization. The consumer can use the unbiased middle entity to modify PII data agreements and/or data.

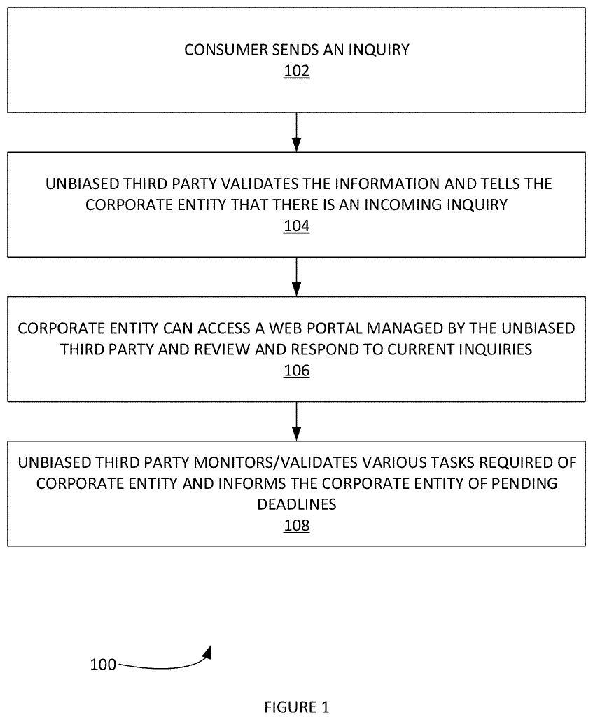

FIG. 1 illustrates an example process for enabling an unbiased middle entity to manage privacy inquiry requirements, according to some embodiments. The is a digitized solution of process 100 can be used for an unbiased third party to test and/or validate and/or govern the timelines of a digital communication between a customer/user and a corporate entity. Example digital communications can include, inter alia: request a policy agreement, change personal data, request information about the consumer's personal data, etc.

It is noted that if the corporate doesn't meet the time, they can be subject to legal penalties. The unbiased third party can attest to corporate compliance with the legal requirements and/or the corporate communications with the consumers. In this way, the corporate entity can protect themselves if their behavior is investigated by a governmental agency.

Process 100 can be used by a user/consumer to access a privacy policy document. When the user/consumer clicks on privacy policy document, they are navigated to an inquiry form. The user can input various information. This can include, inter alia: an email identifier, a jurisdiction of residency, other identifying information, CCPA information, etc. The user/consumer may wish to access this information (e.g. to update/correct it), the form (e.g. a consent check form) is hosted by an unbiased third party. The unbiased third party receives the form and sends the user a validation email (or other electronic communication). The source of the consent check form is an email hyperlink used for confirmation. It is used to verify that the consent check form is not spam related. When the user clicks on the hyperlink, the user receives a message that their inquiry has been submitted. The unbiased third party validates the user action.

More specifically, in step 102, the consumer sends an inquiry. In step 104, the unbiased third party validates the information. The unbiased third party tells the corporate entity that there is an incoming inquiry for them. In step 106, the corporate entity can access a web portal managed by the unbiased third party. The corporate entity can review and respond to the current inquiries. A local law (e.g. CCPA) can include a series of actions that the corporate entity must take in response to the inquiry. These actions can have time constraints. In step 108, the unbiased third party can validate the various tasks required of the corporate entity and inform the corporate entity of pending deadlines. When the corporate entity sends a response, the unbiased third party can forward it to the consumer/user. The user can then receive the reply verifying the corporate response.

In one example, a customer can request that the corporate entity delete some personal content of the customer. The customer can make the request to the unbiased third party that in turn communicates the request to the corporate entity. For example, the unbiased third party can email a hyperlink to the customer to validate the customer's request. Upon receiving the validation, the unbiased third party can make the request to the corporate entity. The corporate entity can communicate the forms needed to update the personal content to the unbiased third party that then documents and forwards it to the consumer for modification. The modifications can be communicated to the corporate entity (e.g. via the unbiased third party) in a timely manner. The unbiased third party can validate, remind, record, and store the various corporate compliance actions.

In another example, process 100 can be adapted to corporate-to-corporate interactions. In this example, the unbiased middle entity tracks times and other information that it takes the corporate entity to respond to the consumer. Do flow between two corporates. For example, a first corporate can be a bank processing mortgage loans for a finance company (i.e. a second corporate). The first corporate can share private information to outside parties (e.g. an appraiser, work status verification, etc. in the mortgage context). The first entity can enable these outside entities (e.g. the appraiser) to use/review the private data for a period of time under a specified set of conditions. This information can be sent to the unbiased middle entity. The unbiased middle entity can store the information and notarize it (e.g. legally record this privacy information). As used herein, notarize can refer to, inter alia, perform acts in legal affairs such as those discussed herein. The unbiased middle entity tracks times and other information that it takes the corporate entity to respond to the consumer.

For example, a first corporate can be a bank processing mortgage loans for a finance company (i.e. a second corporate). The first corporate can share private information to outside parties (e.g. an appraiser, work status verification, etc. in the mortgage context). The first entity can enable these outside entities (e.g. the appraiser) to use/review the private data for a period of time under a specified set of conditions. This information can be sent to the unbiased middle entity. The unbiased middle entity can store the information and notarize it (e.g. legally record this privacy information). The unbiased middle entity can verify that that the private data is deleted when based on the specified conditions. the unbiased middle entity manages the communication and manages the communication between the two corporate parties. The unbiased middle entity can verify that that the private data is deleted when based on the specified conditions. the unbiased middle entity manages the communication and manages the communication between the two corporate parties.

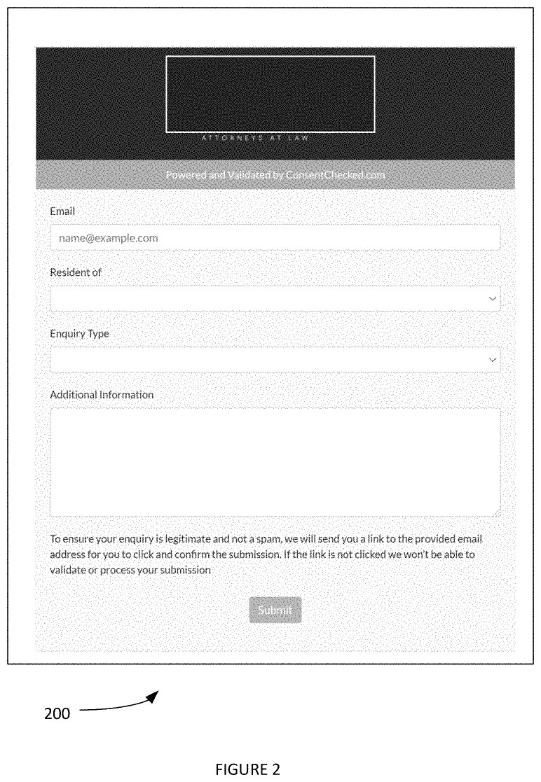

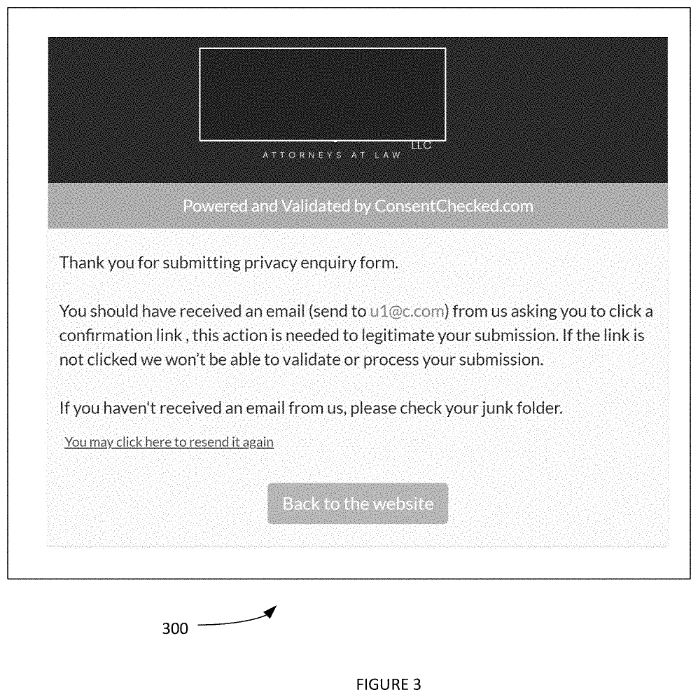

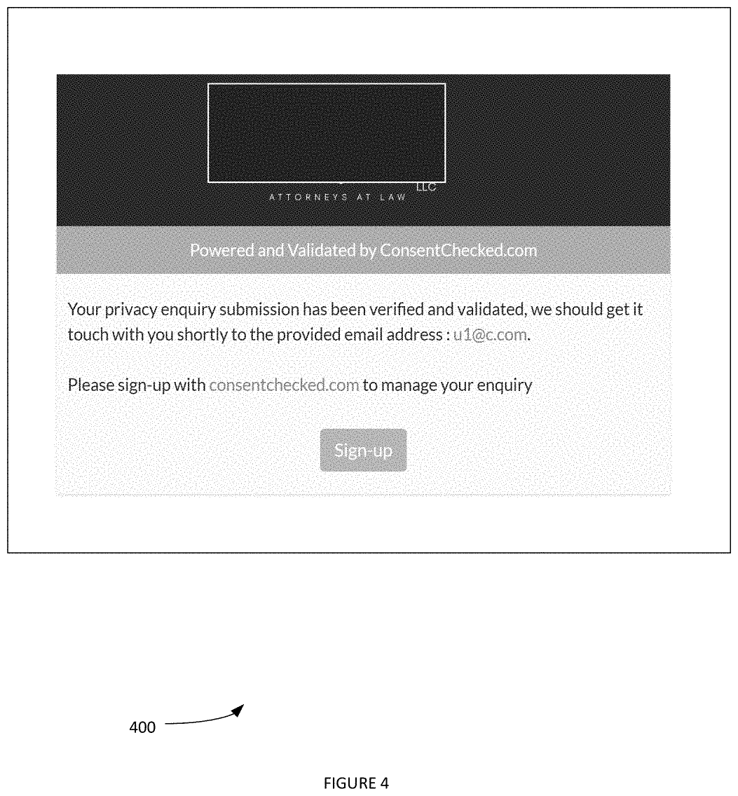

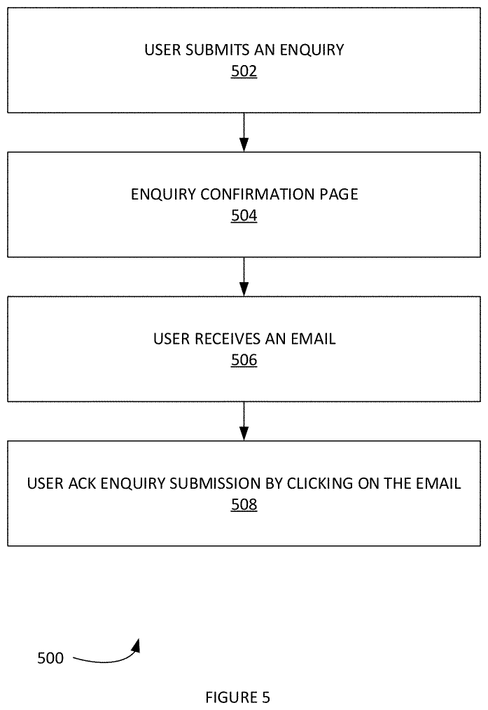

FIGS. 2-4 illustrate example screen shots 200-400 for the implementation of process 1300, according to some embodiments. FIG. 5 illustrates an example process 500 for implementing an enquiry submission, according to some embodiments. In step 502, a user submits an enquiry. In step 504, an enquiry confirmation page is generated. In step 508, a user receives a confirmation email. In step 508, the user acknowledges an enquiry submission by clicking on the email.

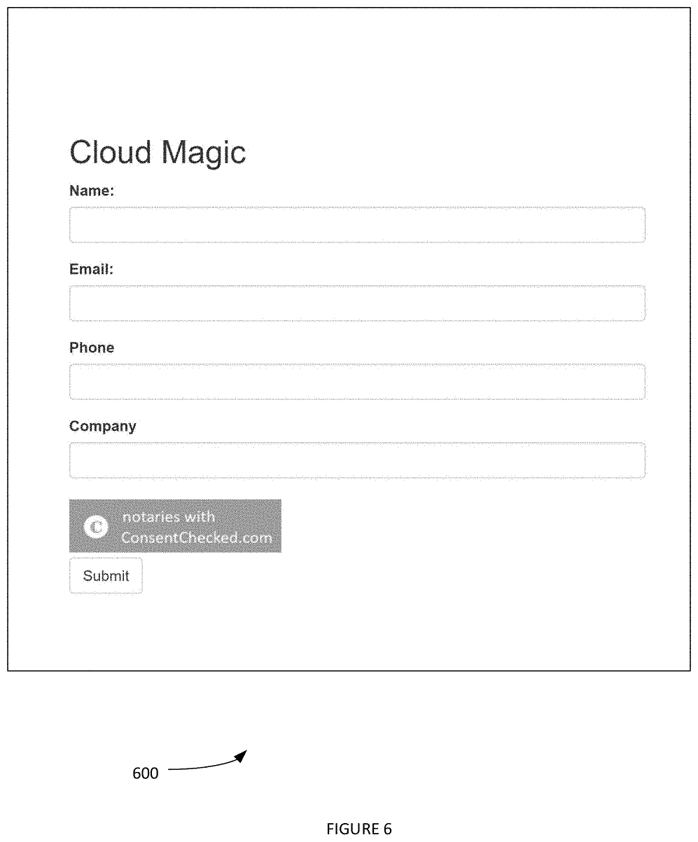

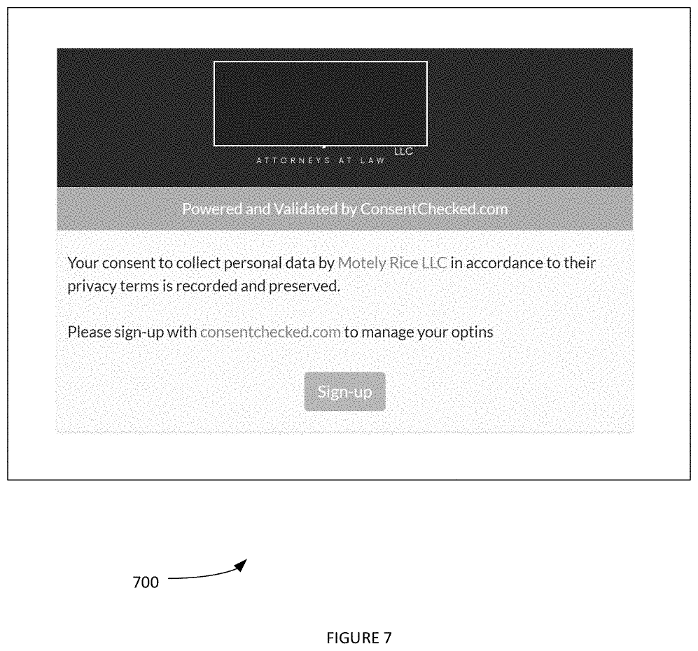

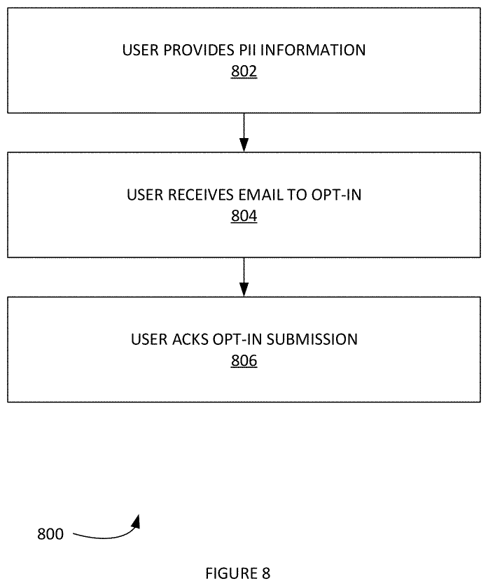

FIGS. 6-7 illustrate a set of example screen shots 600-700 for implementation of process 800, according to some embodiments. FIG. 8 illustrates an example process 800 for implementing an opt-in verification, according to some embodiments. In step 802, the user provides PII information. In step 804, the user receives email to opt-in. In step 806, the user acknowledges the opt-in submission.

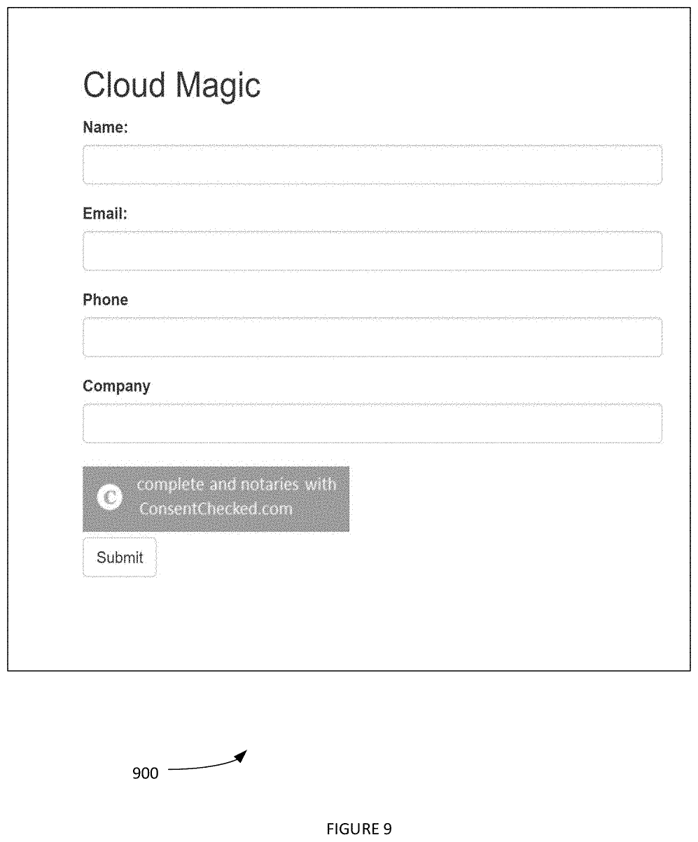

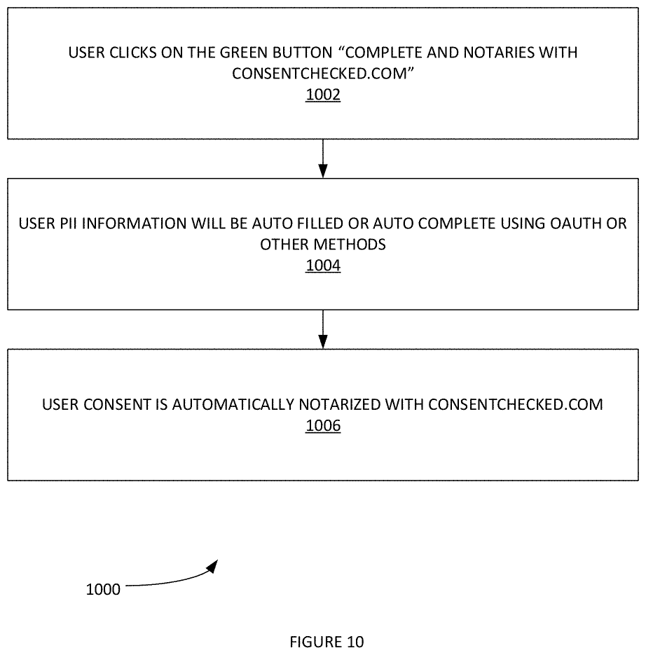

FIGS. 9 and 10 illustrate an example screen shot 900 for implementation of process 1000, according to some embodiments.

FIG. 10 illustrates an example process 1000 for implementing an opt-in verification with auto completion, according to some embodiments. In step 1002, the user clicks the auto complete button shown in the FIG. 9. In step 1004, the user authenticates using OAuth process, sign-in or pin validation with email/SMS user PII information is auto fill PII information. In step 1006, user consent is automatically notarized with the unbiased middle entity.

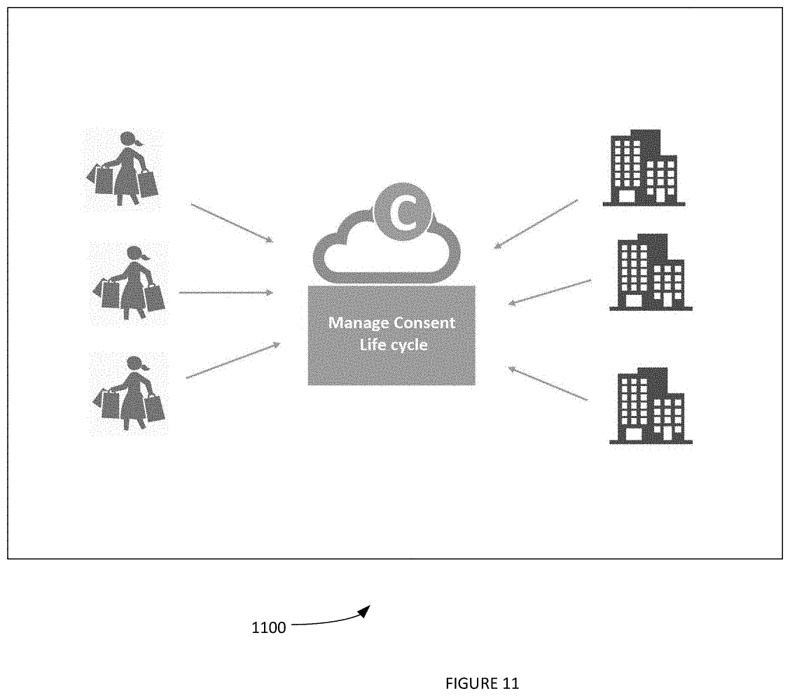

FIG. 11 illustrates an example of a centralized platform that maintains all the interaction between corporates and consumers in one common place, according to some embodiments. This enables the consumer and corporate entities to easily manage their interactions.

The processes used herein can be utilized to manage Corporate-to-Corporate communication can include a corporate entity providing another partner corporate entity a consumer's information. For example, a bank can provide an appraiser a homeowner's information. The corporate entity can authorize another corporate entity to use a consumer's data for a specified time-delimited purpose and then revoke access upon a deadline. In one example, a corporate entity can modify or delete the other corporate entity's access to the consumer data as well.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

1. A digitized system comprising an unbiased entity to verify and notarize/attest digital interactions along with interaction data between parties.

2. The digitized system of claim 1, wherein parties means corporate entities or consumers and between parties refer to corporate to corporate, corporate to consumer, consumer to consumer or group of corporate entities and consumers

3. The digitized system of claim 1, wherein digital interaction comprises consent agreement , data rights access, notifications/alerts, use of services and communications

4. The digitized system of claim 1, wherein verify involves identifying the identity of the parties and their use of digital services

5. The digitized system of claim 4, wherein verification of identity involves verification by email, verification by SMS , verification by login and/or verification by a Hypertext Transfer Protocol (HTTP) cookie.

6. The digitized system of claim 1, wherein notarizing or attesting involves a process of collecting interaction data.

7. The digitized system of claim 6, wherein the interaction data comprises an interaction term, an interaction detail , an interaction message, a time of event, an internet protocol address, a location, a digital fingerprint.

8. The digitized system of claim 7, wherein the system stores the interaction data in a centralized system where the interaction data is accessible to all relevant parties and co-owned along with the unbiased middle entity.

9. The digitized system of claim 8, wherein the system provides a means to download a digitally signed parties interactions and interaction data using an unbiased entity's private key.

10. The digitized system of claim 9, wherein the system shares the digitally signed content with the parties so the subjected parties or legal authorities represented by the parties are able to view the interactions and interaction data using the unbiased entity's public key.

11. The digitized system of claim 3, wherein the consent agreement comprises an acceptance of terms and conditions, and wherein the terms and conditions comprises a privacy term used to collect and use personal information (PII) information, refund policy terms, subscription terms, sale terms and any other business terms.

12. The digitized system of claim 2, wherein data rights access comprises a right to revoke, a right to delete, a right to access, a right to change and any other rights on the accepted terms or collected data.

13. The digitized system of claim 2, wherein notification comprises a digital alert or a message sent by a party to other parties.

14. The digitized system of claim 2, wherein the use of service comprises a use of the software solution to perform a task facilitated by the system.

15. The digitized system of claim 2, wherein digital communication can be any digital messages exchanged between the parties through emails, websites forms, phones.

16. The digitized system of claim 1, further comprising a centralized system hosted by the unbiased entity for parties to view and manage all the consent agreements, an access right , a notification, a use of services and communications.

17. The digitized system of claim 16, wherein the centralized system hosted by the unbiased entity for parties is enabled to register or setup an account, define PII information profile and sharing policies, sign-in, run a report, create a term and conditions, view all interaction and interaction details, and download digitally signed interactions.

18. The digitized system of claim 17, parties can auto fill or auto complete their PII information requested in different websites forms using OAuth, signing-in or using email/SMS pin validation based on the pre-defined PII information profile and sharing policies

19. The digitized system of claim 17, wherein the system tracks critical due deadlines and alerts parties that are due for a response.

20. The digitized system of claim 18, wherein the system provides a standard message templates for parties to respond.
